(19) United States
(12) Patent Application Publication
(10) Pub. No.: US 2008/0224864 A1
(43) Pub. Date: Sep. 18, 2008

(54) Automatic storage box

(76) Inventor: Tsung-Huan Shih, Kaohsiung City (TW)

Correspondence Address: Joe McKinney Muncy, PO Box 1364, Fairfax, VA, 22038-1364, US

(21) Appl. No.: 11/724,288

(22) Filed: Mar. 15, 2007

(51) Int. Cl. G08B 13/08; B65D 43/26; B65D 55/00

(52) U.S. Cl. 340/545.3; 220/211; 220/263

(57) ABSTRACT

The present invention discloses an automatic storage box comprising a bottom case, a receptacle set, a receptacle, a top cover, and a rotary cover set. The inner surface of the bottom case is concaved to form an accommodation basin. A battery bay and a proximity sensor set are respectively arranged at two sides of the accommodation basin, and a dynamic device is arranged therebetween. The receptacle set and the receptacle are respectively detachably installed to the base case. The inner portion of the top cover is concaved downward to form a recess, and the lower rim of the top cover has a positioning element used to engage with the receptacle set. The rotary cover set is arranged above the top cover and pivotally coupled to the receptacle set. When the proximity sensor set detects the approach of a human body, the dynamic device instantly drives the movable cover to rotate to open.

### FIELD OF THE INVENTION

The present invention relates to an automatic storage box, particularly to a storage box, which uses a proximity sensor to detect the approach of the human body and uses a dynamic device to rotate a rotary cover to open or shut the openings of the storage box. Thereby, the automatic box can automatically open or shut, which conveniences the storage or withdrawal of objects, especially on a table or inside a vehicle.

### BACKGROUND OF THE INVENTION

The daily commodities, such as candy, cookie, garbage, etc., have various sizes and are hard to arrange or collect. Therefore, they are likely to be placed randomly, which not only results in disorderliness but also may bring about hygienic problems; for example, insects or mosquitoes may appear, or bacteria may grow. There are various boxes to collect objects, such as candy or cookie, in the market. Those boxes have lids on the tops thereof. After the objects have been placed in the box, the lid is closed. When one intends to access the objects inside the box, he has to pull up the lid. Such a process is usually inconvenient for users. There are also small-size lidless trash cans placed on a table and used to collect small-size wastes. However, such a lidless trash can have the following problems:
1. When the lidless trash is placed on a table or inside a vehicle, it will be sometimes knocked down by an imprudent bump, and the trash will be spilt out; thus, the user has to pick the trash back to the trash can, which reduces the practicability of the conventional lidless trash can.
2. When the lidless trash is placed on a table or inside a vehicle, the trash thereinside can be seen, which influences the appearance and tidiness of the interior and limits the application of the conventional lidless trash can.

### SUMMARY OF THE INVENTION

The primary objective of the present invention is to provide an automatic storage box to solve the problems of the conventional storage box that is disadvantaged in the inconvenience of the manual storage and withdrawal of objects.

To achieve the abovementioned objective, the present invention proposes an automatic storage box, which comprises a bottom case, a receptacle set, a receptacle, a top cover, and a rotary cover set. The inner surface of the bottom case is concaved to form an accommodation basin. A battery bay and a proximity sensor are separately arranged at two sides of the accommodation basin, and a dynamic device is arranged therebetween. The receptacle set and the receptacle are respectively detachably installed in the bottom case. The inner portion of the top cover is concaved downward to form a recess, and the lower rim of the top cover has a positioning member to engage with the receptacle set. The rotary cover set is pivotally installed on the top cover.

The present invention can achieve the following efficacies:
1. The battery bay and the proximity sensor are separately arranged at two sides of the accommodation basin of the bottom base with the dynamic device arranged therebetween. When the proximity sensor detects the approach of a human body, the dynamic device will instantly drive the rotary cover set to rotate to open or shut the openings of the top cover.
2. The automatic storage box of the present invention can be placed on a table or inside a vehicle; therefore, the present invention has high location adaptability and is very convenient for users.
3. When more objects are to be stored, the receptacle can be detached from the receptacle set to increase the accommodation space; thus, the automatic storage box of the present invention can have a good flexibility of the accommodation space.

### BRIEF DESCRIPTION OF THE DRAWINGS

FIG. 1 is a perspective exploded view schematically showing the automatic storage box according to the present invention.

FIG. 2 is a perspective exploded view schematically showing the bottom case and the dynamic device of the automatic storage box according to the present invention.

FIG. 3 is a sectional view schematically showing the assemblage of the automatic storage box according to the present invention.

FIG. 4 is a diagram schematically showing the operation of the transmission set of the automatic storage box according to the present invention.

FIG. 5 is a diagram schematically showing that the automatic storage box according to the present invention is initiated by the approach of the hand.

FIG. 6 is a top view schematically showing the shut state of the movable cover of the automatic storage box according to the present invention.

FIG. 7 is a top view schematically showing the open state of the movable cover of the automatic storage box according to the present invention.

### DETAILED DESCRIPTION OF THE PREFERRED EMBODIMENTS

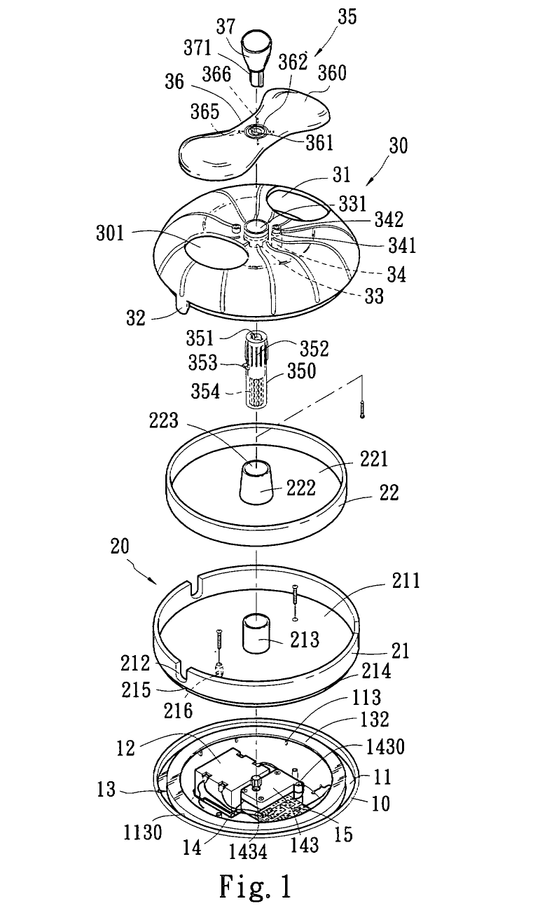

Refer to from FIG. 1 to FIG. 3. The present invention proposes an automatic storage box, which comprises a bottom case 10, a receptacle set 20, a receptacle 22, a top cover 30, and a rotary cover set 35.

The inner surface of the bottom case 10 is concaved to form an accommodation basin 11. One side of the bottom of the accommodation basin 11 has a battery bay 12 to accommodate batteries 121. The other side of the bottom of the accommodation basin 11 has several pillars 111 and 112 used to fix a receiving board 131 of the proximity sensor set 13, a dynamic device 14 and a circuit board 15. At least one protrusion 113 is arranged near the inner rim of the accommodation basin 11, and one of the protrusions 113 has a snap-fit tip 1130 projecting upward. The receiving frame 132 of the proximity sensor set 13 has a snap-fit slot 1321 corresponding to the snap-fit tip 1130. During installing the receiving frame 132, the snap-fit tip 1130 will snap-fit to the snap-fit slot 1321 to position the receiving frame 132 in the accommodation basin 11 of the bottom case 10.

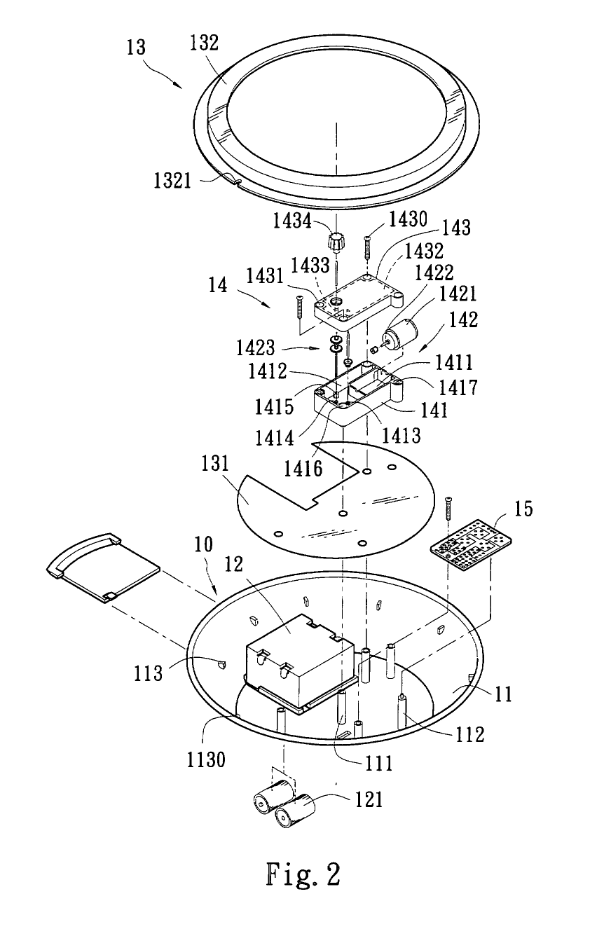

Refer to FIG. 2 again. The dynamic device 14 comprises a casing 141, a transmission set 142 and a cover 143. The interior of the casing 141 is divided into a first accommodation chamber 1411 and a second accommodation chamber 1412. One side of the second accommodation chamber 1412 has a first butt 1413, a second butt 1414 and a third butt 1415, which have different heights. Two through-holes 1416 are formed at one pair of across corners of the casing 141, and two fixing holes 1417 are formed at the other pair of across corner of the casing 141. The transmission set 142 includes a motor 1421 arranged in the first accommodation chamber 1411 and a gear assemblage 1423 arranged in the second accommodation chamber 1412. The motor 1421 utilizes a shaft 1422 to drive the gear assemblage 1423 installed at the first butt 1413, the second butt 1414 and the third butt 1415. The cover 143 has a contour the same as that of the casing 141 and has holes 1431 at the corners and corresponding to the through-holes 1416 and the fixing holes 1417 of the casing 141. Fixing elements 1430, such as screws, are inserted through the holes 1431 of the cover 143 and secured to the pillars 111 of the bottom case 10. The inner surface of the cover 143 is concaved to form an accommodation basin 1432. One side of the accommodation basin 1432 has several protrusions 1433 corresponding to the first butt 1413, the second butt 1414 and the third butt 1415. A rotation block 1434 is arranged in the position corresponding to the third butt 1415 and pivotally coupled to the gear assemblage 1423.

The receptacle set 20 has a receptacle base 21 detachably installed to the bottom case 10. The upper surface of the receptacle base 21 is concaved to form an accommodation basin 211. The rim of the receptacle base 21 has at least one notch 212 (including one notch 212). A hollow pole 213 projects upward from the center of the receptacle base 21 and can accommodates the rotation block 1434 above the cover 143. The perimeter of the bottom of the receptacle base 21 has a convex ring 214 to engage with the bottom case 10. The convex ring 214 has a notch 215 to engage with the snap-fit tip 1130. The bottom of the receptacle base 21 also has a butt 216 used in fixing the receptacle base 21 to the bottom case 10.

The receptacle 22 is accommodated by the receptacle base 21. The upper surface of the receptacle 22 is concaved to form an accommodation basin 221. A hollow 223 pole 222 is formed in the center of the receptacle 22 and can accommodate the pole 213 of the receptacle base 21.

The top cover 30 is installed above the receptacle set 20 and has openings 301 at appropriate positions. The inner portion of the top cover 30 is concaved downward to form a recess 31. The lower rim of the top cover 30 has positioning elements 32 used to engage with the receptacle base 21 of the receptacle set 20. A column 33 projects downward from the center of the top cover 30 and has a through-hole 331. Two flexible pads 342 are respectively inserted into two opposite rods 34 via two opposite holes 341. The bottom of the column 33 has two opposite arc-shape notches 332 used to clamp two opposite block element 333.

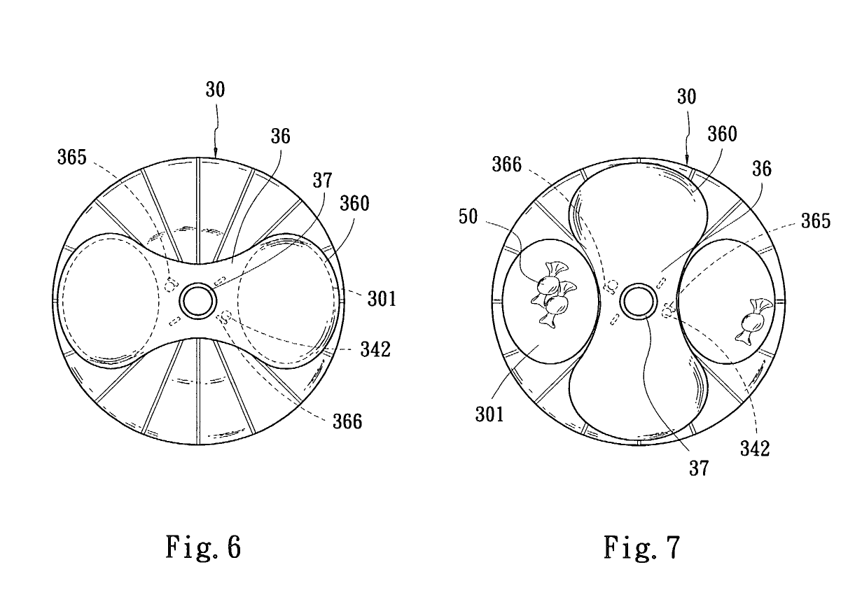

The rotary cover set 35 is pivotally coupled to the receptacle set 20 and the top cover 30 above the receptacle 22. The rotary cover set 35 further comprises a rotary shaft 350, a movable cover 36 and a snap-fit knob 37. The rotary shaft 350 has a snap-fit hole 351 and a keyhole 352 at one end and has two opposite block elements 353 near the end. The two block elements 353 rotate to and fro inside the arc-shape notches 332 of the column 33 and snap-fit to the two block elements 333. The other end of the rotary shaft 350 has a snap-fit hole 354 interconnecting the keyhole 352. A rotary block 1434 is installed in the snap-fit hole 354. The movable cover 36 is pivotally installed above the rotary shaft 350. In the embodiment shown in the drawings, the movable cover 36 appears like the shape of 8. Two opposite cover leaves 360 respectively project outward from the center of the movable cover 36. The center of the movable cover 36 is a concaved surface 362 having a snap-fit hole 361. A protrusion member 364 having an accommodation chamber 363 is formed on the side opposite to the concaved surface 362. The accommodation chamber 363 sleeves one end of the rotary shaft 350. A pair of opposite protrusion elements 365 and a pair of opposite protrusion elements 366 are installed on the perimeter of the protrusion member 364 and respectively press against two opposite flexible pads 342 from the left side and right side. As shown in FIG. 6 or FIG. 7, when the transmission set 142 drives the movable cover 36, the two opposite cover leaves 360 will rotate to open or shut the corresponding openings 301. The snap-fit element 371 at one end of the snap-fit knob 37 is inserted into the snap-fit hole 361 of the movable cover 36 and the snap-fit hole 351 of the rotary shaft 350. The appearance of the snap-fit knob 37 has decorative flowers, animals, etc. to meet the requirement of the customer.

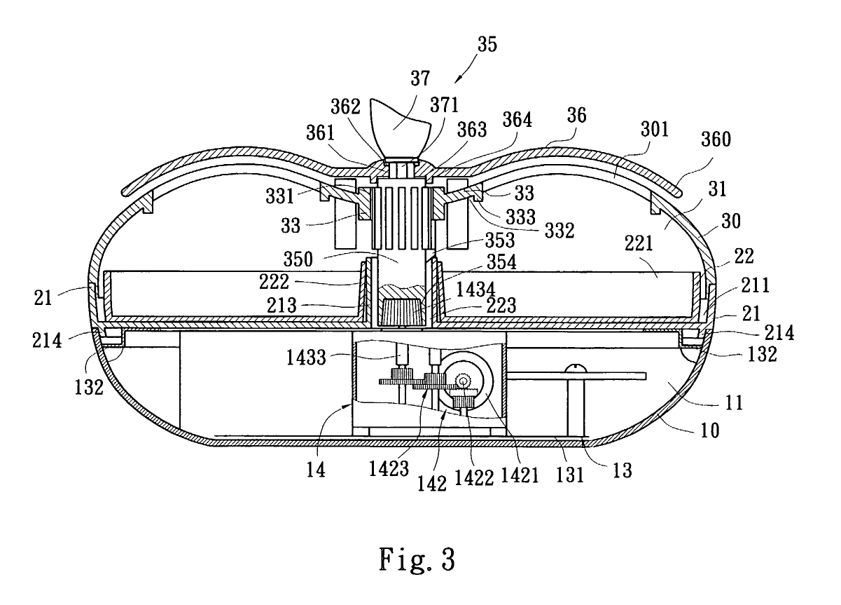

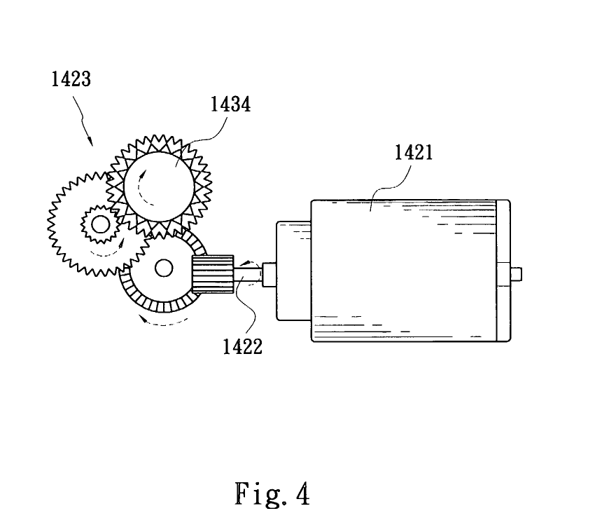

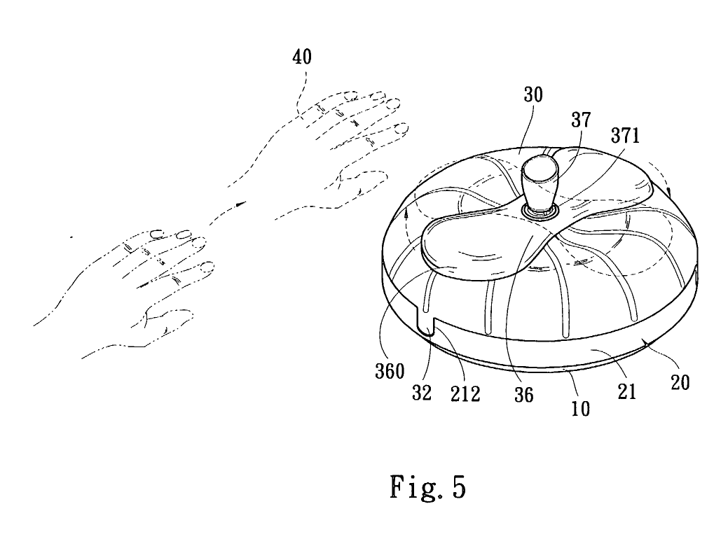

In the present invention, the top cover 30 may has at least one opening 301 (including one opening 301). In the embodiment shown in the drawings, the two openings 301 are corresponding to the movable cover 36 and arranged oppositely in the top cover 30. Refer to from FIG. 3 to FIG. 5. The automatic storage box of the present invention may be placed on a table or inside a vehicle. Refer to FIG. 6 and FIG. 7. When the proximity sensor set 13 detects the approach of a human body, the transmission set 142 of the dynamic device 14 will drive the gear assemblage 1423 to rotate the movable cover 36 pivotally coupled to the dynamic device 14. The movable cover 36 will thus be instantly opened from the original shut state. Then, the user can access the objects placed on the receptacle 22 of the receptacle set 20. In the drawings, the objects are exemplified with candies 50. The circuit board 15 of the bottom case 10 may be preset to automatically shut the movable cover 36 after the hand 40 has left the automatic storage box for several seconds. Thus, the present invention can achieve the objective of conveniently storing/withdrawing objects into/from the automatic storage box placed on a table or inside a vehicle.

Besides, when more objects are to be stored, the receptacle 22 can be taken away, and only the receptacle base 21 is used to accommodate objects. Thus, the automatic storage box of the present invention can have a larger accommodation space.

What is claimed is:

1. An automatic storage box, comprising the following components:
a bottom case, wherein the inner surface of said bottom case is concaved to form an accommodation basin; one side of the bottom of said accommodation basin has a battery bay to accommodate batteries; a proximity sensor set, a dynamic device, and a circuit board are arranged on the other side of the bottom of said accommodation basin, and said dynamic device is located near said battery bay; a rotation block is arranged above said dynamic device and pivotally coupled to said dynamic device;
a receptacle set having a receptacle base that has an accommodation basin and is detachably installed to said bottom case;
a receptacle detachably installed to said accommodation basin of said receptacle base;
a top cover having openings at appropriate positions, wherein a column projects downward from the center of the top cover; the inner portion of said top cover is concaved downward to form a recess; the lower rim of said top cover has a positioning element used to engage with said receptacle base of said receptacle set; and
a rotary cover set pivotally coupled to said receptacle set and said top cover above said receptacle and further comprising a rotary shaft, a movable cover and a snap-fit knob, wherein said rotary shaft is pivotally coupled to said rotation block above said dynamic device; said movable cover is arranged above said rotary shaft; said snap-fit knob is inserted through said movable cover into said rotary shaft and assembled to them, wherein when said proximity sensor set detects the approach of a human body, said dynamic device instantly drives said movable cover to rotate to open or shut said openings.

2. The automatic storage box according to claim 1, wherein at least one protrusion (including one protrusion) is arranged near the inner rim of said accommodation basin of said bottom case, and one of said protrusions has a snap-fit tip projecting upward.

3. The automatic storage box according to claim 1, wherein said proximity sensor set further comprises a receiving frame arranged on said accommodation basin of said bottom case and a receiving frame installed on said accommodation basin of said bottom case.

4. The automatic storage box according to claim 1, wherein said dynamic device further comprises a casing, a transmission set and a cover; the interior of said casing is divided into a first accommodation chamber and a second accommodation chamber; one side of said second accommodation chamber has a first butt, a second butt and a third butt, which have different heights; two through-holes are formed at one pair of across corners of said casing, and two fixing holes are formed at the other pair of across corner of said casing; said transmission set includes a motor arranged in said first accommodation chamber and a gear assemblage arranged in said second accommodation chamber; said motor utilizes a shaft to drive said gear assemblage installed at said first butt, said second butt and said third butt; said cover has a contour the same as that of said casing and has holes at the corners and corresponding to said through-holes and said fixing holes of said casing; the inner surface of said cover is concaved to form an accommodation basin; one side of said accommodation basin has several protrusions corresponding to said first butt, said second butt and said third butt; a rotation block is arranged in the position corresponding to said third butt and pivotally coupled to said gear assemblage.

5. The automatic storage box according to claim 1, wherein said accommodation basin of said receptacle base is fabricated into a recess and has at least one notch (including one notch) at its rim; a hollow pole projects upward from the center of said receptacle base; the perimeter of the bottom of said receptacle base has a convex ring to engage with said bottom case; said convex ring has a notch to engage with a snap-fit tip of said bottom case; the bottom of said receptacle base also has a butt used in fixing said receptacle base to said bottom case.

6. The automatic storage box according to claim 1, wherein said receptacle is arranged inside said accommodation basin of said receptacle base; the upper surface of said receptacle is concaved to form an accommodation basin; a hollow pole is formed in the center of said receptacle and can accommodate a hollow pole of said receptacle base.

7. The automatic storage box according to claim 1, wherein said top cover has at least one opening (including one opening) corresponding to said movable cover; when there are more than two said openings (including two said openings), said openings are arranged oppositely.

8. The automatic storage box according to claim 1, wherein said movable cover appears like the shape of 8; two opposite cover leaves respectively project outward from the center of said movable cover; the center of said movable cover is a concaved surface having a snap-fit hole; said snap-fit knob has a snap-fit element to be inserted into said snap-fit hole; a protrusion member having an accommodation chamber is formed on the side opposite to said concaved surface; a pair of opposite protrusion elements and a pair of opposite protrusion elements are installed on the perimeter of said protrusion member.

9. The automatic storage box according to claim 1, wherein said rotary shaft has a snap-fit hole and a keyhole at one end and has two opposite block elements near the end; the other end of said rotary shaft has a snap-fit hole interconnecting said keyhole.

10. The automatic storage box according to claim 1, wherein said column of said top cover has a through-hole; the bottom of said column has two opposite arc-shape notches used to clamp two opposite block element.

11. The automatic storage box according to claim 1, wherein two flexible pads are respectively inserted into two opposite rods of said top cover; said pair of opposite protrusion elements and said pair of opposite protrusion elements of said movable cover respectively press against said two opposite flexible pads.
